(19) United States
(12) Patent Application Publication
(10) Pub. No.: US 2002/0011974 A1
(43) Pub. Date: Jan. 31, 2002

(54) Addressing of electroluminescent displays

(75) Inventor: Antonius Hendricus Maria Holtslag, Eindhoven, NL (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/908,596

(22) Filed: Jul. 19, 2001

(30) Foreign Application Priority Data
Jul. 28, 2000 (EP) 00202706.8

(51) Int. Cl. G09G 3/30

(52) U.S. Cl. 345/76

(57) ABSTRACT

A method of illuminating an electro-luminescent device, the method comprising allocating a plurality of sub-frame time periods to each data frame, and using plasma display drivers to generate illuminating pulses in each sub-frame time period.

### DESCRIPTION

The present invention relates to a method of addressing electro-luminescent displays, and can be applied to AC- or DC- driven thick film or thin film electro-luminescent devices.

An electro-luminescent device typically comprises an array of pixels formed by one or more layers of phosphor, embedded in dielectric, between row and column metal electrodes. Rows are addressed sequentially and this is known as “line at a time” addressing, and pixels are selected by addressing the appropriate column. Voltage pulses of about 150 volts are typically applied to the row electrodes in odd frames and negative pulses in the even frames. This corresponds to the threshold value for illuminating a pixel. Columns are addressed with negative pulses in odd frames and positive in even frames (the pulses are modulated between 0 and 50 volts). In DC driven devices the polarity of pulses does not change but the row and column polarity differs. This combination illuminates appropriate pixels to effect the desired display. The higher the voltage applied, the higher the luminescence of the phosphor and the brighter the pixel. Thus grey scales are determined by the value of the voltage applied. To obtain 256 grey scale values 256 voltage values need to be selected between the threshold voltage for illuminating a pixel, and the maximum voltage applied, ie between about 150 and 200 volts. However, the relationship between luminescence and applied voltage is not always linear and further inaccuracies occur because of voltage coupling between pixels. In addition, the generation of grey scale in the display requires analogue signals to be developed from digital signals and this requires complex drivers which are expensive and tend to exhibit an unsatisfactory level of reliability.

Plasma displays relatively readily produce the desired range of grey scale because a plasma medium has an inherent memory and voltage pulses are used, together with a sustaining level of an appropriate frequency to cause the plasma pixel to emit the desired level of luminescence. Plasma display panel (PDP) drivers are available off-the-shelf in the marketplace in a wide variety of specifications and outputs and are relatively cheap. However, plasma display drivers are not readily adaptable to electro-luminescent (EL) devices because of their inherent lack of memory compared to plasma. The difficulty of applying plasma drivers is discussed in U.S. Pat. No. 5,652,600.

U.S. Pat. No. 5,652,600 proposes a modulation method for Thin Film electro-luminescent (TFEL) devices to provide a grey scale display. An Active Matrix electro-luminescent device is illuminated by dividing each data frame into sub-frame time periods, and controlling the illumination of pixels by altering a predetermined characteristic (such as frequency, amplitude, wave-shape or time duration) of the illuminating signal from subframe to sub-frame while selectively illuminating pixels during each sub-frame. The differences in the characteristic of the illuminating signals provide differences in pixel luminescence levels.

The present invention aims to provide an improved method of illuminating an electro-luminescent device.

According to one aspect of the present invention there is provided a method of illuminating an electro-luminescent device, the method comprising allocating a plurality of sub-frame time periods to each data frame, and using display drivers to generate illuminating pulses in each sub-frame time period. The display drivers are preferably well known plasma display drivers.

The present method is passive and performs addressing line at a time and thus requires less driver switches, and is thus more cost effective than active matrix addressing. For example, for an array of N×M cells, N×M driver switches are needed for active addressing but only N+M driver switches are needed for passive addressing.

According to a preferred embodiment of the invention each plasma display panel driver comprises a push-pull MOSFET pair, with an output switchable between two predetermined voltage levels. The rows of the display are addressed line-at-a-time and row pulses and column pulses have opposite polarity. The polarity of each of the row pulses and the column pulses may be changed after each frame, or alternatively may be changed continuously (after each sub-frame pulse). Changing polarity after each sub-frame pulse is the preferred embodiment because, under certain circumstances, when polarity is changed after each frame, it can happen that the first pulse in the frame will produce more light than the others.

Advantageously further features of PDP drivers can be used, eg gamma correction, dithering or error diffusion, pulse contrasting and motion estimation. These features are known as ways of improving PDP performance but were not previously applicable to EL displays because of the inherent analogue nature of the grey-scale generation in such displays as previously known.

Preferably there are 16 or more sub-frame time periods in each data frame. Often 16 is the maximum useful number of sub-frames, particularly when using traditional phosphors such as Zns; Mn, SrS, Ce. This is because typical decay times of such phosphors are 1-2 ms and with a typical frame rate of 50-60 Hz, saturation of the phosphor occurs at about 1 Khz. However if phosphors with faster decay times or longer frame times are used then the sub-frame rate can be correspondingly increased.

According to a second aspect of the invention there is provided a method of using Plasma Display Panel (PDP) drivers for AC driven electro-luminescent devices, even though PDP drivers generally only deliver positive pulses. The method comprises using PDP drivers to apply either zero volts or a positive polarity pulse of a first predetermined voltage (eg 50 V), and applying an offset negative voltage of a magnitude greater than the first predetermined voltage (eg a voltage of 150V) to the signal to be applied to the rows, and using a PDP driver delivering either zero volts or a second predetermined positive pulse of a magnitude greater than the magnitude of the offset voltage and greater than the first predetermined voltage.

For example, the first predetermined voltage may be 50V, the offset voltage may be −150V and the second predetermined voltage may be +350V. Then the row driver voltage will alternate between −150-V and +200V giving an absolute difference of 150V or 200V across the EL device whilst the polarity across the device still alternates after each pulse. If the row driver is at 200V the column driver pulse can be inverted (50V=low, 0V=high). Luminance increases with increasing voltage difference (as shown later in FIG. 2) up to a region of saturation (which can also be used).

The method of the invention may also be applied to any other fast switching display using line-at-a-time addressing. Very fast switching LCD displays may also be driven this way.

For a better understanding of the present invention, and to show how the same may be carried into effect, reference will now be made to the accompanying drawings in which:

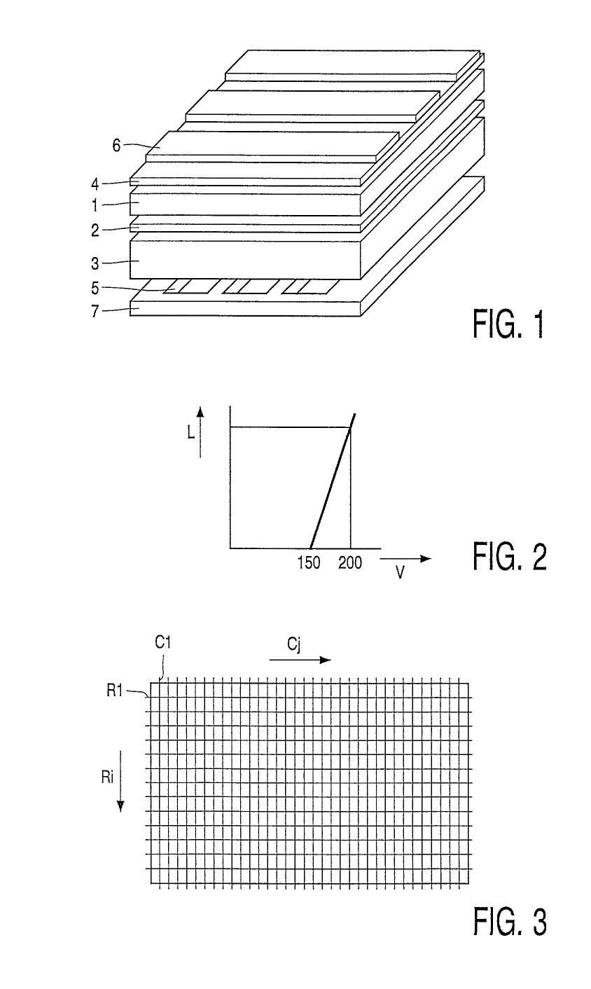

FIG. 1 is a 3D cross-section of an AC driven thick-film electro-luminescent structure to which the present invention may be applied.

FIG. 2 is a graph showing the linear part of a typical voltage-luminance characteristic for an electro-luminescent structure.

FIG. 3 schematically illustrates the principle of line-at-a-time addressing.

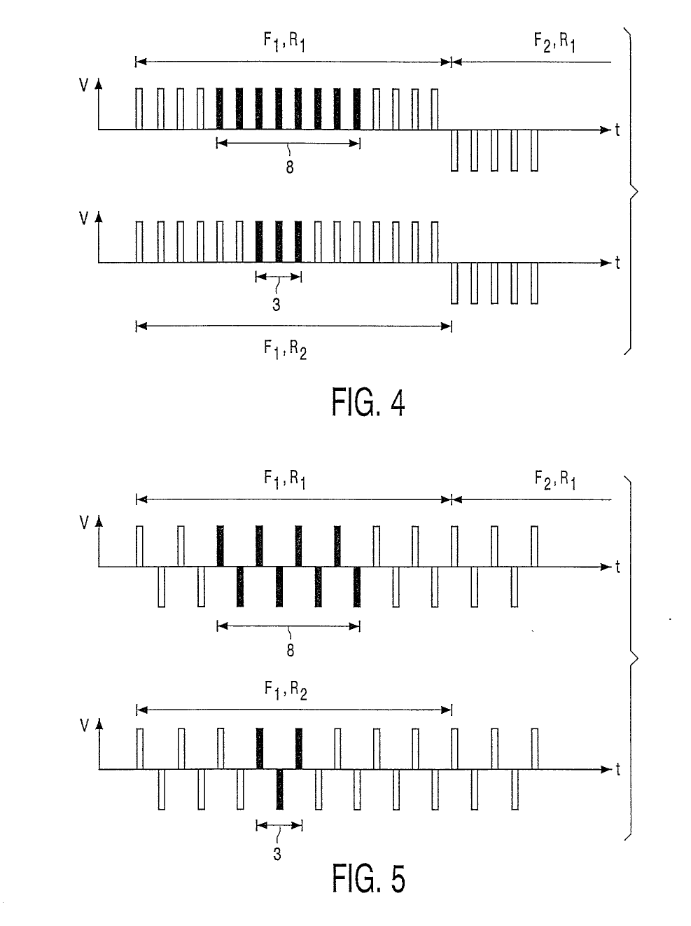

FIG. 4 illustrates one embodiment of pulse polarity switching applied to the addressing method of the invention.

FIG. 5 illustrates a second embodiment of pulse polarity switching applied to the addressing method of the invention.

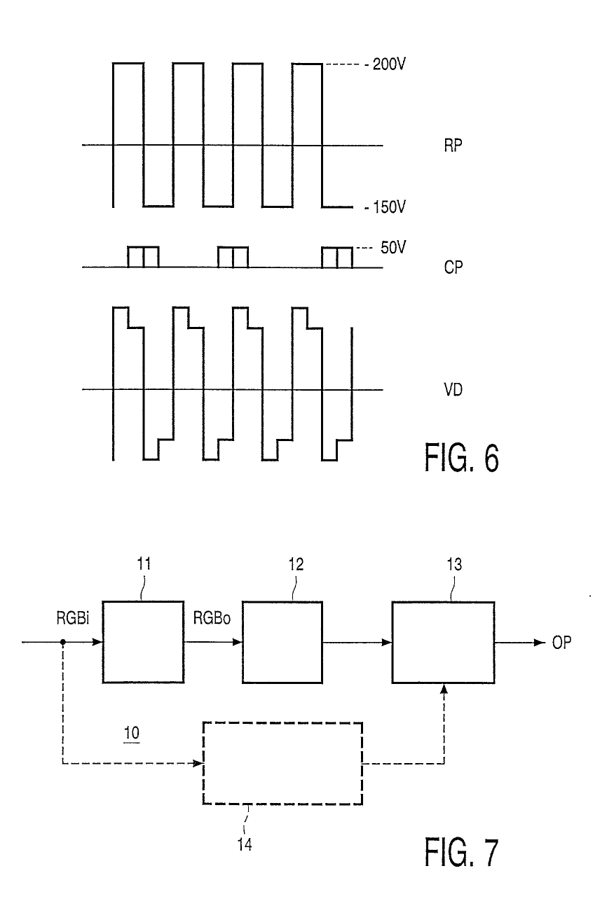

FIG. 6 illustrates a practical realisation of how the pulses of FIG. 5 may be applied.

FIG. 7 is a flow diagram illustrating further improvements in the method of the invention.

In FIG. 1 it can be seen that a thick film electro-luminescent structure formed of a phosphor layer 1 coating an MOD planarization 2 and sandwiched between a thick film dielectric 3 and a thin film dielectric 4, located between metal electrodes 5 and 6, and is mounted on an alumina substrate 7.

Voltages are applied to the electrodes so that typically a voltage between 150V and 200V is experienced by the phosphor layer at the junction of a row Ri and a column electrode Cj (see FIG. 3) at the point which is to be illuminated, ie at a particular pixel. The level of the voltage V determines the level of luminance L, ie the brightness, and in theory this relationship is a directly proportional one as shown by the graph of FIG. 2. Thus traditional grey scale levels are determined by the number of discrete voltage values which can be selected in the range of 150V to 200V. Typically for good display definition 256 values are necessary. Voltage pulses are applied to the rows Ri sequentially, ie line-at-a-time, as illustrated by the grid of FIG. 3, and row pulses and column pulses have opposite polarity.

FIG. 4 and 5 show voltage pulses applied to a pixilated display according to two different embodiments of the invention.

Each frame F is divided into 16 sub-frames or fields as illustrated. Each of the 16 sub-frame pulses is capable of illuminating a pixel. In the top line of FIGS. 4 and 5 value 8 is turned on in the columns, and in the bottom line value 3 is turned on. The sub-frame pulses are fired in the middle of the frame. The label F1, R1 indicates frame 1, row 1; the label F2, R1 indicates frame 2, row 1, and so on.

In FIG. 4 the polarity of the voltage pulses changes after each frame, whereas in FIG. 5 the polarity changes after each sub-frame pulse and this is the preferred embodiment since it tends to give a more consistent output. Changing polarity only once each frame can cause more light to be produced from the first pulse in a frame than in the other.

The pulses shown illustrate the effective time and polarity that a display is activated.

FIG. 6 illustrates a practical realisation of the pulses applied. The voltage levels of the row pulses RP and the column pulses CP are indicated. The lowest pulses show the voltage difference VD between the row pulses RP and the column pulses CP.

FIG. 7 illustrates a possible processing sequence of the pulse signal. An RGB signal RGBi at 60 Hz is input to the processor indicated generally at 10, as an 8 bit signal. This signal is first gamma corrected by gamma correction circuitry 11, the output of which is a 10 bit signal RGBo.

Then error diffusion is effected at 12 to create sufficient grey-scale levels by producing 16 pulses (4 bit) at a sub-frame rate of 960 Hz while the error is diffused towards the other pixels. The error diffuser 12 may for example operate on the Floyd-Steinberg principal. A pulse centraliser 13 ensures that the pulses OP are fired in the middle of the frame, with respect to time, in order to limit motion artifacts.

A motion estimation compensation circuit 14 may be used to determine the speed of objects in the image to be displayed and to correct further for the time and position shifts of the pixels.

When the PDP driver is used for AC driven electro-luminescent devices then a row driver offset is introduced at −150V, producing either Ov or a 350V pulse giving a net row driver voltage which changes between −150V and +200V. The absolute difference is thus either 150V or 200V across the electro-luminescent device. The polarity is alternated each pulse.

If the row driver is at 200V then the pulses of the column driver are inverted to make 50V the low state and zero volts the high state.

1. A method of illuminating an electro-luminescent device, the method comprising allocating a plurality of sub-frame time periods to each data frame, and using display drivers to generate illuminating pulses in each sub-frame time period.

2. A method according to claim 1 wherein each display driver comprises a push-pull MOSFET pair, with an output switchable between two predetermined voltage levels.

3. A method according to claim 1 or claim 2 wherein the rows of the display are addressed line-at-a-time and row pulses and column pulses have opposite polarity.

4. A method according to any one of the preceding claims wherein the polarity of each of the row pulses and the column pulses is changed after each frame.

5. A method according to any one of claims 1 to 3 wherein the polarity of each of the row pulses is changed after each sub-frame pulse.

6. A method according to any one of the preceding claims further comprising using any one or more of the features of gamma correction, dithering, error diffusion, pulse contrasting and motion estimation.

7. A method according to any one of the preceding claims wherein there are 16 or more sub-frame time periods in each data frame.

8. A method according to claim 1 wherein the display driver comprises a plasma display driver.

9. A method of using Display Panel (DP) drivers for AC driven electro-luminescent devices, the method comprising using DP drivers to apply either zero volts or a positive polarity pulse of a first predetermined voltage (eg 50 V), and applying an offset negative voltage of a magnitude greater than the first predetermined voltage to the signal to be applied to the rows, and using a driver delivering either zero volts or a second predetermined positive pulse of a magnitude greater than the magnitude of the offset voltage and greater than the first predetermined voltage.

10. Apparatus for driving an electro-luminescent display device, the apparatus comprising display drivers arranged to generate illuminating pulses in each of a plurality of sub-frame time periods within each data frame.

11. Apparatus according to claim 10 comprising luminescent pixels formed of phosphors.

12. Apparatus according to claim 11 wherein the phosphor is taken from the group consisting of Zns, Mn, SrS, Ce.

13. Apparatus according to claim 10 wherein the display driver comprises a plasma display driver.

14. A fast switching display comprising apparatus according to any one of claims 10 to 13.
